(19) United States
(12) Patent Application Publication
(10) Pub. No.: US 2012/0308089 A1
(43) Pub. Date: Dec. 6, 2012

(54) METHOD OF BIOMETRIC AUTHENTICATION BY USING PUPIL BORDER AND APPARATUS USING THE METHOD

(75) Inventor: Eui Chul LEE, Seoul (KR)

(73) Assignee: KOREA BASIC SCIENCE INSTITUTE, Daejeon (KR)

(21) Appl. No.: 13/239,827

(22) Filed: Sep. 22, 2011

(30) Foreign Application Priority Data
Jun. 3, 2011 (KR) 10-2011-0054149
Jul. 19, 2011 (KR) 10-2011-0071551

(51) Int. Cl. G06K 9/00

(52) U.S. Cl. 382/117

(57) ABSTRACT

A method of biometric authentication based on unique information obtained from a pupil. The method includes: acquiring an image of a pupil and an iris; extracting a pupil region from the image; and generating unique biometric information by extracting a specific pattern of the pupil from the pupil region. The method performs biometric authentication by combining unique information obtained from a pupil region with unique information obtained from an iris region.

### CROSS-REFERENCE TO RELATED PATENT APPLICATION

This application claims the benefit of Korean Patent Application Nos. 10-2011-0054149, filed on Jun. 3, 2011, and 10-2011-0071551, filed on Jul. 19, 2011 in the Korean Intellectual Property Office, the disclosure of which is incorporated herein in its entirety by reference.

### BACKGROUND OF THE INVENTION

1. Field of the Invention

The present invention relates to a method of recognizing unique information from a shape of a pupil border and an apparatus using the method.

2. Description of the Related Art

From among methods of recognizing human bodies, methods using irises have been actively studied because the methods using irises have higher accuracy, higher stability, and higher authentication speeds (Reference: (1) G., AnnaPoorani, R. Krishnamoorthi, P., Gifty Jeya, S., Petchiammal, “Accurate and Fast Iris Segmentation”, International Journal of Engineering Science and Technology, Vol. 2(6), pp. 1492-1499, 2010, and (2) Zhaofeng He, Tieniu Tan, Zhenan Sun, and Xianchao Qiu, “Towards Accurate and Fast Iris Segmentation for Iris Biometrics”, IEEE Transactions on PAMI, vol. 31, No. 9, pp. 1670-1684, 2009).

However, the methods using irises have disadvantages in that the methods are sensitive to a surrounding environment such as ambient light or reflected light of illumination and noise generated due to eye blinking of a user reduces the accuracy of iris recognition (Reference: (3) Kazuyuki Miyazawa, Koichi Ito, Takafumi Akoki, Koji Kobayashi and Hiroshi Nakajima, “A Phase-Based Iris Recognition Algorithm,” Advances in Biometrics: International Conference, ICB 2006, pp. 356-365, Hong Kong, China, January 2006). Recently, in order to increase a recognition accuracy, a method of detecting a pupil region which is robust against reflected light (Reference: (4) Meen-Hwan Cho, Jung-Youn Hur, “The Study on Searching Algorithm of the Center of Pupil for the Iris Recognition”, Korea Society of Computer Information, Vol. 11, 2006), a filtering method of extracting features (Reference: (5) John G. Daugman, “How Iris Recognition Works,” IEEE Trans. on Circuits and Systems for Video Technology, Vol. 14, No. 1, pp. 21-29, 2004), and a method of detecting an eyelid (Reference: (6) R. Krishnamoorthy and D. Indradevi. 2011. Fast and iterative algorithm for iris detection with orthogonal polynomials transform. In Proceedings of the 2011 International Conference on Communication, Computing & Security (ICCCS '11). ACM, New York, N.Y., USA, 325-330.) have been suggested. However, a recognition accuracy is still reduced because an iris region is occluded by eye blinking or ambient noise is generated when an iris image is acquired from an eye image.

Korean Patent Registration No. 0572410 B1 discloses a method of estimating a pupil region in order to perform rapid iris recognition. That is, during iris recognition, a recognition rate varies according to a surrounding environment, for example, reflected light or the brightness of ambient light, and if an iris is occluded due to eye blinking of a user which is uncontrollable, the accuracy of the iris recognition may be reduced.

Korean Patent Registration No. 1051433 B1 discloses a method of obtaining a plurality of pieces of bio-information such as a size of a pupil and a speed/frequency of eye blinking from an eye image. Although the method performs emotion recognition through interaction between a machine (computer) and a user by tracking a state of the user, the method may not be used to recognize unique information of the user, that is, may not perform individual identification.

### SUMMARY OF THE INVENTION

The present invention provides a method of recognizing biometric information, which may rapidly acquire unique biometric information while being hardly affected by ambient image noise, and an apparatus using the method.

According to an aspect of the present invention, there is provided a method of recognizing biometric information, the method including: acquiring an image of a pupil and an iris; extracting a pupil region from the image; and generating unique biometric information by extracting a specific pattern of the pupil border from the pupil region.

According to another aspect of the present invention, there is provided an apparatus for recognizing biometric information, the apparatus including: an image capturing unit that acquires an image of a pupil and an iris; an information processing unit that extracts a specific pattern of the pupil border from the image and generates unique biometric information from the specific pattern of the pupil border; and a storage unit that stores the unique biometric information.

The specific pattern may be obtained from a border of the pupil region.

The specific pattern may be calculated from a change in radii between a center of gravity and positions on a pupil border of the pupil.

The generating of the unique biometric information may include: determining a center of gravity of the pupil by using information about the pupil region; calculating distances (radii) between the center of gravity and positions on a pupil border of the pupil at predetermined angles (360 degrees/N, where N is a natural number); and determining the unique biometric information by obtaining an difference between a radius of an arbitrary position and a radius of a position adjacent to the arbitrary position and converting the difference to a binary value based on an arbitrary reference value.

A difference between adjacent distances may correspond to raw data of the unique biometric information and the raw data may be converted to a binary value.

The method may further include: generating unique biometric information from an iris region; and combining the unique biometric information obtained from the pupil region with the unique biometric information obtained from the iris region.

The combining of the unique biometric information may include combining the unique biometric information obtained from the pupil region with the unique biometric information obtained from the iris region at any one of a feature level, a score level, and a decision level.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an apparatus for biometric authentication, according to an embodiment of the present invention;

FIG. 2 is a flowchart illustrating a method of recognizing unique biometric information, according to an embodiment of the present invention;

FIG. 3 is a photograph illustrating an example where a center of a pupil is detected by using a circular edge detection (CED) algorithm;

FIG. 4 is a diagram for explaining a process of extracting unique information from a pupil border;

FIG. 5 is a diagram illustrating a process of comparing original information with newly acquired information;

FIG. 6 is a photograph illustrating a relationship between a size of a pupil of a person and an ambient illumination intensity;

FIG. 7 is a graph illustrating a distribution of biometric information formed on a two-dimensional (2D) plane having an axis of Hamming distances obtained by comparing pieces of pupil border information and an axis of Hamming distances obtained by comparing pieces of iris information, according to the method of FIG. 2;

FIG. 8 is a graph for explaining whether a user is accepted or rejected when pupil border information and iris information are combined by using an AND rule in the distribution of FIG. 7;

FIG. 9 is a graph for explaining whether a user is accepted or rejected when pupil border information and iris information are combined by using an OR rule in the distribution of FIG. 7;

FIG. 10 is a graph for explaining an XOR problem of a linear classifier due to a result of imposter matching having a specific distribution; and

FIG. 11 is a graph illustrating a non-linear classifier used to solve the XOR problem of the linear classifier of FIG. 10.

### DETAILED DESCRIPTION OF THE INVENTION

The present invention will now be described more fully with reference to the accompanying drawings, in which exemplary embodiments of the invention are shown.

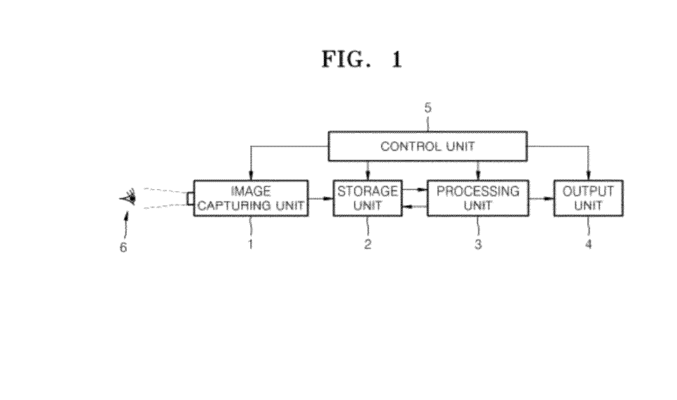

FIG. 1 is a block diagram illustrating an apparatus for biometric authentication, according to an embodiment of the present invention.

Referring to FIG. 1, an image capturing unit 1 such as a camera photographs an eye 6 of a user to obtain image information and transmits the image information to a storage unit 2, and an information processing unit 3 processes the image information stored in the storage unit 2. In this case, information processed by the information processing unit 3 is obtained from a pupil region, and iris unique information obtained from an iris region is also processed by the information processing unit 3. The two pieces of unique information obtained from the pupil region and the iris region are combined. Such information fusion is performed at any one of a feature level, a score level, and a decision level which will be explained later. A result of biometric recognition obtained by the information processing unit 3 in this manner is output through an output unit 4. The information processing unit 3 reads information from the storage unit 2, and then information, that is, unique biometric information, is stored in the storage unit 2 through a process which will be explained later. Examples of the storage unit 2 may include a semiconductor memory such as a random access memory (RAM) or a ferroelectric random access memory (FRAM), a magnetic memory such as a hard disc drive (HDD), and a storage medium such as an optical disc drive (ODD). A database including a plurality of pieces of unique biometric information may be stored in the storage unit 2. The information processing unit 3 compares newly acquired unique biometric information with unique biometric information registered in the database, and determines whether the newly acquired unique biometric information is previously registered in the database. All of the above components of the apparatus for biometric authentication are controlled by a control unit 5, and the control unit 5 controls functions of the components ranging from capturing an image to outputting a result.

The output unit 4 may include at least one information output device such as a monitor, a printer, or an acoustic device. The afore-described components may be provided by a general computer device or an exclusive computer system-based device on which a moving image or still image camera is mounted. Some functions of the information processing unit 3 for calculating final unique biometric information and original data by processing an image may be supported by software or firmware.

A method of recognizing biometric information by driving the apparatus constructed as described above will be explained.

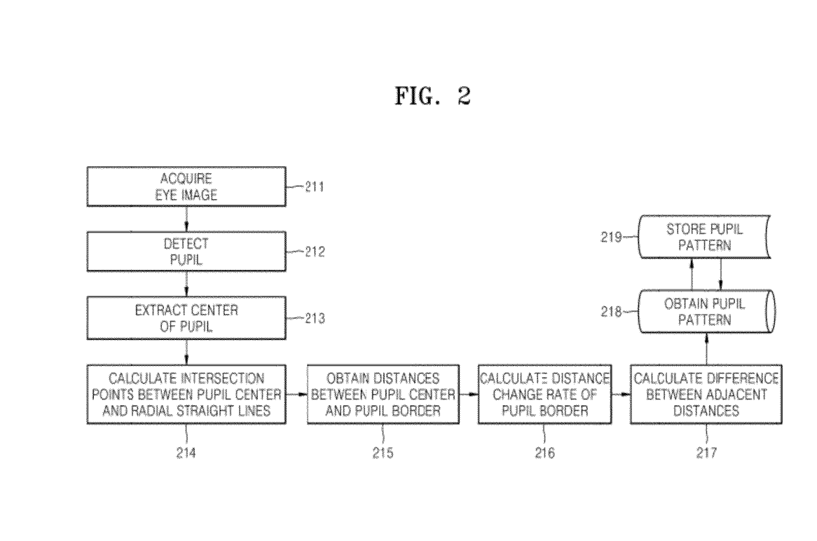

FIG. 2 is a flowchart illustrating a method of recognizing unique biometric information, according to an embodiment of the present invention.

In operation 211, an eye image of a user including a pupil and an iris is captured by using a camera. In operation 212, the pupil is detected from the eye image. If it is determined that a face portion other than an eye exists, a face region and an eye region should be detected before the pupil is detected, by using, for example, an AdaBoost (short for Adaptive Boosting) method. The AdaBoost method may be capable of rapidly and simply detecting a face with relatively high accuracy and may operate in real time. Non-Patent Document 8 (Robust Real-Time Face Detection) discloses an AdaBoost method, and the face region may be extracted by using the AdaBoost method disclosed in Non-Patent Document 8. After the face region is extracted, and before a pupil region is extracted, the eye region should be detected, by using, for example, the AdaBoost method. In order to extract the eye region, information obtained by combining multiple weak classifiers which reflects characteristics of the eye is used.

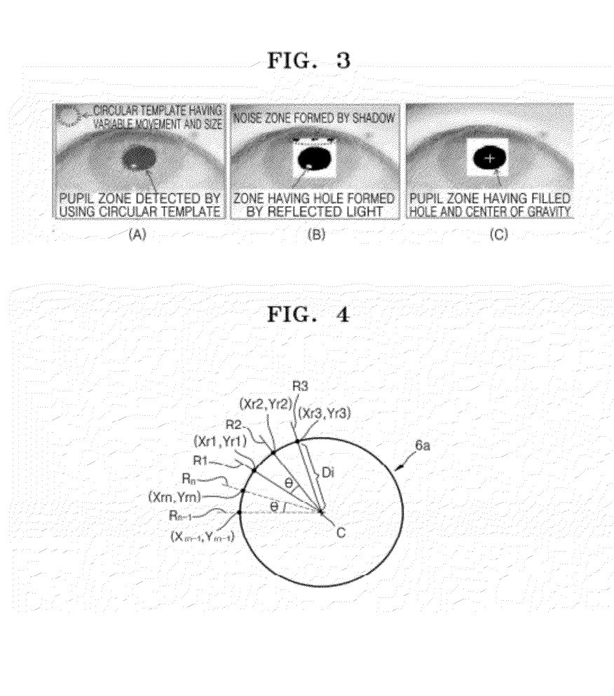

Meanwhile, in operation 212, the following circular edge detection algorithm is used. First, as shown in (A) of FIG. 3, an initial pupil region is determined by using circular template matching. The circular template matching may be described by the following equation, and a method suggested by Cheol Woo Cho or the like may be referred to in this case (Reference: (7) Cheol Woo Cho, Ji Woo Lee, Eui Chul Lee, Kang Ryoung Park, “A Robust Gaze Tracking Method by Using Frontal Viewing and Eye Tracking Cameras”, Optical Engineering, Vol. 48, No. 12, 127202, December 2009).

$${max}_{( r , {x}_{0} , {y}_{0} )} {\vert}_{T} {G}_{σ} ( r ) * \frac{\partial }{\partial r} {∮}_{r , {x}_{0} , {y}_{0}} \frac{I ( x , y )}{2 π r} d s \vert \qquad ( 1 )$$

where I(x, y) represents a gray lever of an image at a position (x, y), and (x₀, y₀) and r represents a center and a radius of a circular template. As a result, a point where a difference between sums of gray levels of two circular templates is the highest is determined as a pupil region. However, since a pupil may be oval, rather than circular, according to a camera angle or a gaze position, the position determined by using the circular template matching may not be accurate. Accordingly, local binarization as shown in (B) of FIG. 3 based on the determined position is performed. Since a quadrangular local region is divided into a pupil region (foreground) and a region (background) other than the pupil region, a threshold value of the local binarization is obtained by using a method suggested by Gonzalez or the like (Reference: (9) http://en.wikipedia.org/wiki/Thresholding_(image_processing)) and a method of automatically determining a threshold value suggested by Otzu (Reference: (10) N. Otsu, “A Threshold Selection Method from Gray-Level Histograms”, IEEE Transactions on SMC, Vol. SMC-9, No. 1, pp. 62-66, January 1979). After the local binarization, a noise region formed by an eyelid or a shadow may exist and a hole may appear when reflected light exists in the pupil region. To prevent this, component labeling is performed to assign identities to adjacent regions, and regions having identities different from an identity of a largest region are removed, to remove the noise region. Finally, morphological closing is performed in order to fill the hole. As a result, in operation 213, a center of gravity of a black (pupil) region as shown in (C) of FIG. 3 is obtained, and determined as a final pupil center.

In operation 214, distances between a pupil center (Xp, Yp) and a pupil border 6a that is a line along which a black pixel changes to a white pixel in the pupil region are obtained. Since the morphological closing makes a border of a binarized figure unclear, in order to determine pupil border information, the image of (B) of FIG. 3 before the morphological closing is performed is used. In this case, the distances are radii between the pupil center (Xp, Yp) and n (for example, 256) positions on the pupil border 6a as shown in FIG. 4. That is, intersection points (Xr₁, Yr1)˜(Xrn, Yrn) between the pupil center (Xp, Yp) and radial straight lines CR₁˜CRₙ arranged at equal angles are obtained. In operation 215, n distances Dᵢ, (for example, i=0˜255) between the pupil center (Xp, Yp) and the pupil border 6a are obtained. In operation 216, after the distances D₀˜Dn between the pupil center (Xp, Yp) and the intersection points (Xr₁, Yr1)˜(Xrn, Yrn) are obtained, a radius (distance) change rate of the pupil border 6a is calculated.

In operation 217, a difference (i.e., Oᵢ=Dᵢ−Dᵢ₋₁) between a radius of an arbitrary position and a radius of a position adjacent to the arbitrary position is obtained for each of the n distances obtained above. In operation 219, if a difference between a radius of an arbitrary Ith point xᵢ and a radius of a point xᵢ₋₁ adjacent to the arbitrary Ith point xᵢ is equal to or less than 0, 0 is assigned and if the difference is greater than 0, 1 is assigned, and then a result of such binarization is stored as binary patterns of unique pupil border information.

Bᵢ=0; if (Oᵢ−Oᵢ₋₁)≦0

Bᵢ=1; if (Oᵢ−Oᵢ₋₁)>0 (2).

If it is determined that during such border information detection, border information is lost because reflected infrared light falls on a border between the pupil and the iris, corresponding information may not be used. Accordingly, if a brightness of a point in a circular image having 256 straight lines arranged at 1.406 degrees is greater than a predetermined number, for example, 250, it is determined that wrong information is detected due to reflected light of illumination. 256 binary patterns having such validity information (valid: 1, invalid: 0) are configured separately from one border information binary pattern.

The above-described binary pupil border information may be stored as unique biometric information in a database and used as original information to be compared with new information, or may be compared with original information of the database that stores a plurality of previously registered pieces of unique biometric information and used to determine whether it is previously registered information or new information.

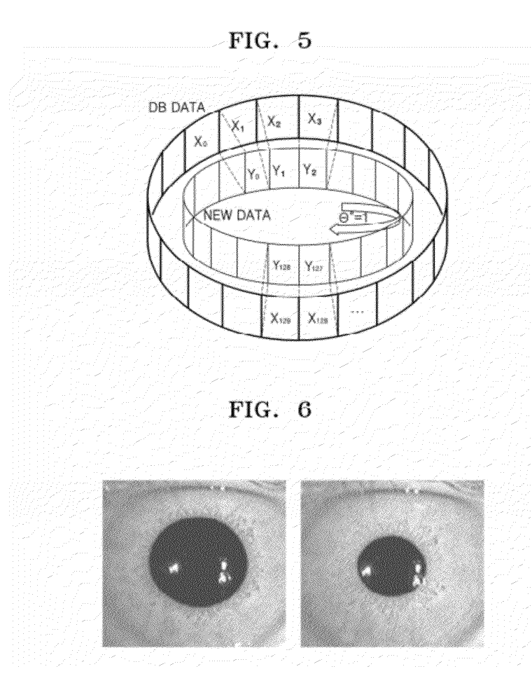

In order to determine a same person or another person through biometric recognition by using comparison with original information of a database, it is necessary to compare original information (e.g., DB data) with newly acquired information (New data) as shown in FIG. 5. It is determined whether a user is the same person by determining whether a stored pupil pattern Eᵢ is in a one-to-one correspondence relationship with a newly acquired pupil pattern Nᵢ when a face rotates in a predetermined range (θ), for example, a range of −20 to +20 degrees. FIG. 5 shows two pieces of data matched to each other. In this case, the newly obtained information (New data) may be circularly shifted in the range θ in consideration of a rotation amount of the face, and one having a lowest Hamming distance is selected. In conventional iris recognition, a Hamming distance measurement method is used to compare a 2048-bit binary pattern. In the present embodiment, a Hamming distance measurement method as shown in Equation 3 may be used to perform binary pattern matching.

$$HD = \frac{‖ ( code A ⊗ code B ) ⋂ mask A ⋂ mask B ‖}{‖ mask A ⋂ mask B ‖} \qquad ( 3 )$$

As is well known in the art, codeA and codeB denote two pupil border information binary patterns, and maskA and maskB denote validity information binary patterns of the pupil border information binary patterns codeA and codeB. code A \textcircled{x} code B denotes an XOR (Exclusive OR) operation using a Hamming distance to confirm that the patterns are the same, and mask A and mask B denote pattern validity tests. Accordingly, it is determined whether pupil patterns are identical to each other by using a result of the XOR operation and a result of the intersection of the mask A and mask B.

Although a number of distances to a pupil border is limited to 256 in the above embodiment, the number may be 512 or 1024 in order to extract more precise information. Such a number of sampled distances does not limit the scope of the present invention. Also, although a pupil pattern is obtained by using a difference between a plurality of sampled radii or distances, the difference may be binarized by using other operations or calculations. That is, a method of calculating a unique pupil pattern from a plurality of sampled distances or radii may be performed in various other ways.

FIG. 6 is a photograph illustrating a relationship between an ambient illumination intensity and a size of a pupil of a person. After comparing a plurality of binarized pupil patterns acquired under various illumination intensities, it is found that the pupil patterns are the same in a predetermined range irrespective of the various illumination intensities, and thus pupil border information may be used as unique information like iris information to identify an individual.

According to the method of the present invention, since a specific pattern of a pupil is used as unique biometric information, a decrease in a recognition accuracy due to the effect of light in a surrounding environment such as ambient light or reflected light which is a disadvantage of iris recognition may be prevented and a decrease in a recognition accuracy due to noise caused by eye blinking or the like may also be prevented. Also, iris recognition may be more efficiently conducted with respect to a user with small eyes. For example, a recognition accuracy may be increased through multi-modal biometric recognition by combining iris recognition and pupil recognition.

Pupil border information and iris information may be extracted from one image obtained from a human eye. In this case, an iris region should be included in the image. An eye region is detected from the image, and iris information and pupil information are acquired from the eye region. The iris information is acquired by using an existing method, and the pupil information is acquired by using the above-described method. In order to biometric authentication by using the iris information and the pupil information, these two pieces of information need to be combined. As a method of combining two pieces of information, a method suggested by Arun Ross and Anil Jain (Reference: (11) “Information Fusion in Biometrics”, Arun Ross, Anil Jain, Pattern Recognition Letters 24 (2003) 2115-2125) may be referred to.

The two pieces of information may be combined at a feature level, a score level, or a decision level that will be explained later, to obtain combined information, and the combined information may be used in multi-model biometric recognition.

Fusion at a feature level involves simply combining 256-bit information extracted from a pupil border and 2048-bit information extracted from an iris. Accordingly, 2304-bit biometric information may be obtained by adding the 256-bit information to the 2048-bit information. The 2304-bit biometric information is compared with previously registered 2034-bit biometric information stored in a database by using the above-described method, to determine whether a user is the same person.

Fusion at a score level involves, when Hamming distances HDp obtained by comparing two pieces of pupil border information (captured new pupil border information and pupil border information registered in a database) and Hamming distances HDi obtained by comparing two pieces of iris information are defined as scores for the information, obtaining one representative value by adding the Hamming distances (HDp+HDi) or multiplying the Hamming distances (HDp*HDi). New biometric information may be read by using the one representative value.

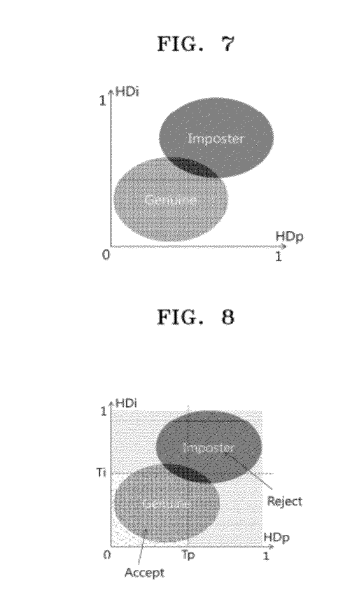

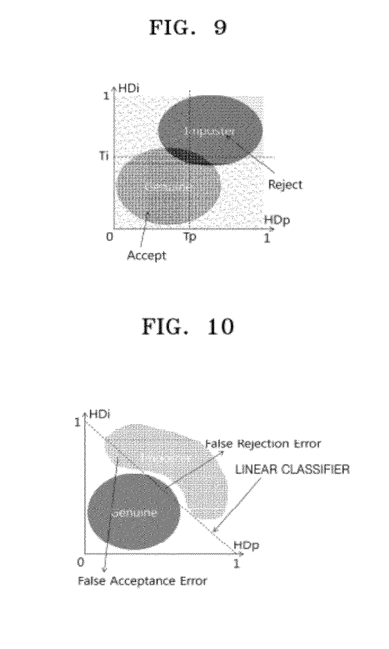

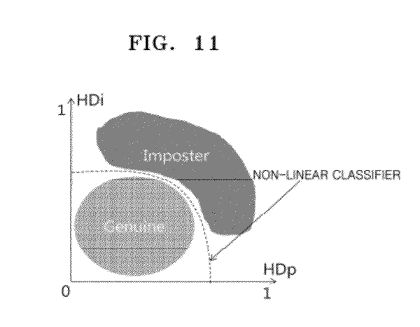

In fusion at a decision level, when a result obtained from genuine matching (using a comparison between a plurality of pieces of information obtained from the same person) and a result obtained from imposter matching (using a comparison between a plurality of pieces of information obtained another person) are expressed on a two-dimensional (2D) plane having an axis of the Hamming distances HDp obtained by comparing pieces of pupil border information and an axis of the Hamming distances HDi obtained by comparing pieces of iris information, a distribution as shown in FIG. 7 is formed. When the two results are combined by using an AND rule, if the iris information and the pupil information have values equal to or less than two threshold values Ti and Tp, the user is accepted, and if the iris information and the pupil information do not have values equal to or less than the two threshold values Ti and Tp, the user is rejected, as shown in FIG. 8. When the two results are combined by using an OR rule, if only one of the iris information and the pupil information has a value equal to or less than the threshold value Ti or Tp, the user is accepted as shown in FIG. 9. Meanwhile, if there are distributions as shown in FIGS. 10 and 11, since a linear classifier has a severe error due to an XOR problem (e.g., a false acceptance error as shown in FIG. 10), an appropriate classifier may be determined by using non-linear classification such as a support vector machine (SVM) suggested by Suykens or the like (Reference: (12) Suykens, J. A. K., Vandewalle, J., “Least Squares Support Vector Machine Classifiers”, Neural Processing Letters, 1999 Jun. 1, pp. 293-300, Volume: 9, Issue: 3).

### FOREIGN PATENT DOCUMENTS

1. KR 0572410 B1 2006 Apr. 12
2. KR 2011-0035585 A 2011 Apr. 6

### OTHER PUBLICATIONS

1. G., AnnaPoorani, R. Krishnamoorthi, P., Gifty Jeya, S., Petchiammal, “Accurate and Fast Iris Segmentation”, International Journal of Engineering Science and Technology, Vol. 2(6), pp. 1492-1499, 2010.
2. Zhaofeng He, Tieniu Tan, Zhenan Sun, and Xianchao Qiu, “Towards Accurate and Fast Iris Segmentation for Iris Biometrics”, IEEE Transactions on PAMI, vol. 31, No. 9, pp. 1670-1684, 2009.
3. Kazuyuki Miyazawa, Koichi Ito, Takafumi Akoki, Koji Kobayashi and Hiroshi Nakajima, “A Phase-Based Iris Recognition Algorithm,” Advances in Biometrics: International Conference, ICB 2006, pp. 356-365, Hong Kong, China, January 2006.
4. Meen-Hwan Cho, Jung-Youn Hur, “The Study on Searching Algorithm of the Center of Pupil for the Iris recognition”, Korea Society of Computer Information, Vol. 11, 2006
5. John G. Daugman, “How Iris Recognition Works,” IEEE Trans. on Circuits and Systems for Video Technology, Vol. 14, No. 1, pp. 21-29, 2004.
6. R. Krishnamoorthy and D. Indradevi. 2011. Fast and iterative algorithm for iris detection with orthogonal polynomials transform. In Proceedings of the 2011 International Conference on Communication, Computing & Security (ICCCS '11). ACM, New York, N.Y., USA, 325-330.
7. Cheol Woo Cho, Ji Woo Lee, Eui Chul Lee, Kang Ryoung Park, “A Robust Gaze Tracking Method by Using Frontal Viewing and Eye Tracking Cameras”, Optical Engineering, Vol. 48, No. 12, 127202, December 2009.
8. Viola, P. and Jones, M. J. “Robust Real-Time Face Detection”. Int. J. Comput. Vis. 57, 137-154 (2004)
9. http://en.wikipedia.org/wiki/Thresholding_(image_processing)
10. N. Otsu, “A Threshold Selection Method from Gray-Level Histograms”, IEEE Transactions on SMC, Vol. SMC-9, No. 1, pp. 62-66, January 1979.
11. Arun Ross, Anil Jain, “Information Fusion in Biometrics”, Pattern Recognition Letters 24 (2003) 2115-2125
12. Suykens, J. A. K., Vandewalle, J., “Least Squares Support Vector Machine Classifiers”, Neural Processing Letters, 1999 Jun. 1, pp. 293-300, Volume: 9, Issue: 3

What is claimed is:

1. A method of recognizing biometric information, the method comprising:
acquiring an image comprising a pupil and an iris;
extracting a pupil region from the image; and
generating unique biometric information by extracting a specific pattern of the pupil from the pupil region.

2. The method of claim 1, wherein the unique biometric information is obtained from a border of the pupil region.

3. The method of claim 2, wherein the unique biometric information is calculated from a plurality of distances sampled from the border of the pupil region.

4. The method of claim 2, wherein the unique biometric information is calculated from a change in distances sampled from the border of the pupil region.

5. The method of claim 1, wherein the generating of the unique biometric information comprises:
determining a center of gravity of the pupil by using information about the pupil region;
calculating distances (radii) between the center of gravity and positions on a pupil border of the pupil at predetermined angles (360 degrees/N, where N is a natural number); and
determining the unique biometric information by obtaining a difference between a radius of an arbitrary position and a radius of a position adjacent to the arbitrary position and converting the difference to a binary value based on an arbitrary reference value.

6. The method of claim 2, wherein the generating of the unique biometric information comprises:
determining a center of gravity of the pupil by using information about the pupil region;
calculating distances (radii) between the center of gravity and positions on a pupil border of the pupil at predetermined angles (360 degrees/N, where N is a natural number); and
determining the unique biometric information by obtaining a difference between a radius of an arbitrary position and a radius of a position adjacent to the arbitrary position and converting the difference to a binary value based on an arbitrary reference value.

7. The method of claim 3, wherein the generating of the unique biometric information comprises:
determining a center of gravity of the pupil by using information about the pupil region;
calculating distances (radii) between the center of gravity and positions on a pupil border of the pupil at predetermined angles (360 degrees/N, where N is a natural number); and
determining the unique biometric information by obtaining a difference between a radius of an arbitrary position and a radius of a position adjacent to the arbitrary position and converting the difference to a binary value based on an arbitrary reference value.

8. The method of claim 4, wherein the generating of the unique biometric information comprises:
determining a center of gravity of the pupil by using information about the pupil region;
calculating distances (radii) between the center of gravity and positions on a pupil border of the pupil at predetermined angles (360 degrees/N, where N is a natural number); and
determining the unique biometric information by obtaining a difference between a radius of an arbitrary position and a radius of a position adjacent to the arbitrary position and converting the difference to a binary value based on an arbitrary reference value.

9. The method of claim 5, further comprising:
generating unique biometric information from an iris region; and
combining the unique biometric information obtained from the pupil region with the unique biometric information obtained from the iris region.

10. The method of claim 9, wherein the combining of the unique biometric information comprises combining the unique biometric information obtained from the pupil region with the unique biometric information obtained from the iris region at any one of a feature level, a score level, and a decision level.

11. An apparatus for recognizing biometric information, the apparatus comprising:
an image capturing unit that acquires an image comprising a pupil and an iris;
an information processing unit that extracts a specific pattern of the pupil from the image and generates unique biometric information from the specific pattern of the pupil; and
a storage unit that stores the unique biometric information.

12. The apparatus of claim 11, wherein the information processing unit obtains the unique biometric information from a border of a pupil region.

13. The apparatus of claim 11, wherein the information processing unit calculates the unique biometric information from a plurality of distances sampled from a border of a pupil region.

14. The apparatus of claim 11, wherein the information processing unit calculates the unique biometric information from a change in distances sampled from a border of a pupil region.

15. The apparatus of claim 11, wherein the information processing unit:
determines a center of gravity of the pupil by using information about a pupil region;
calculates distances (radii) between the center of gravity and positions on a pupil order of the pupil at predetermined angles (360 degrees/N, where N is a natural number); and
determines the unique biometric information by obtaining a difference between a radius of an arbitrary position and a radius of a position adjacent to the arbitrary position and converting the difference to a binary value based on a sign of the difference.

16. The apparatus of claim 12, wherein the information processing unit:
determines a center of gravity of the pupil by using information about a pupil region;
calculates distances (radii) between the center of gravity and positions on a pupil order of the pupil at predetermined angles (360 degrees/N, where N is a natural number); and
determines the unique biometric information by obtaining a difference between a radius of an arbitrary position and a radius of a position adjacent to the arbitrary position and converting the difference to a binary value based on a sign of the difference.

17. The apparatus of claim 13, wherein the information processing unit:
determines a center of gravity of the pupil by using information about a pupil region;
calculates distances (radii) between the center of gravity and positions on a pupil order of the pupil at predetermined angles (360 degrees/N, where N is a natural number); and
determines the unique biometric information by obtaining a difference between a radius of an arbitrary position and a radius of a position adjacent to the arbitrary position and converting the difference to a binary value based on a sign of the difference.

18. The apparatus of claim 14, wherein the information processing unit:
determines a center of gravity of the pupil by using information about a pupil region;
calculates distances (radii) between the center of gravity and positions on a pupil order of the pupil at predetermined angles (360 degrees/N, where N is a natural number); and
determines the unique biometric information by obtaining a difference between a radius of an arbitrary position and a radius of a position adjacent to the arbitrary position and converting the difference to a binary value based on a sign of the difference.

19. The apparatus of claim 15, wherein the information processing unit:
generates unique biometric information from an iris region; and
combines the unique biometric information obtained from the pupil region with the unique biometric information obtained from the iris region.

20. The apparatus of claim 19, wherein the information processing unit combines the unique biometric information obtained from the pupil region with the unique biometric information obtained from the iris region at any one of a feature level, a score level, and a decision level.
